(19) United States
(12) Patent Application Publication
(10) Pub. No.: US 2025/0188958 A1
(43) Pub. Date: Jun. 12, 2025

(54) EXTERNAL PRESSURE FLUID RESERVOIR FOR STORING ENERGY

(71) Applicant: Energy Vault, Inc., Westlake Village, CA (US)

(72) Inventor: Mauro Pedretti-Rodi, Canobbio (CH)

(21) Appl. No.: 18/845,390

(22) PCT Filed: Feb. 6, 2023
(86) PCT No.: PCT/CH2023/050003

§ 371 Date: Sep. 9, 2024

(30) Foreign Application Priority Data
Mar. 18, 2022 (CH) CH000298/2022

(51) Int. Cl. F15B 1/10

(52) U.S. Cl. CPC F15B 1/106; F15B 2201/315; F15B 2201/405; F15B 2201/415; F15B 2201/605

(57) ABSTRACT

The invention relates to an external pressure fluid reservoir which has: an interior for receiving a fluid; an external wall to which, during operation, pressure is applied by an external pressure from the external environment and which separates the interior from the external environment in a fluid-tight manner; and a connection, which is provided between the interior and the external environment, for selectively exchanging fluid between the interior and the external environment; wherein the interior is formed by a bulk material filling and the wall is designed such that, during operation, said wall absorbs an external pressure exceeding the pressure in the interior and introduces it into the bulk material filling which in turn supports said wall, in its operating position, against the excess external pressure.

The present invention relates to an external pressure fluid reservoir according to the preamble of claim 1, and a method for producing such an external fluid pressure reservoir according to claim 21.

Storing energy has become more important since the production of renewable energy as such has gained in importance. Many types of renewable energy are subject to weather conditions (sun, wind), which are not necessarily put to use at the time they are produced. Consequently, it only makes sense to generate energy obtained from the sun or wind in the form of heat or electricity if it can be stored until needed, i.e. when weather conditions make it impossible to produce in sufficient amounts.

There are thermal reservoirs for storing heat, and there are pumped hydroelectricity storage systems (PHS systems) or pressure vessels for storing electricity, in which electricity is used to pump water in PHS systems to a higher elevation, which can then be used to power generators to generate electricity it is not otherwise available. In pressure vessels, a fluid that can be pressurized, such as air, is compressed by electric compressors and stored in a pressure vessel until the pressurized fluid can be used to power turbines coupled to generators to produce electricity on demand, while energy is stored for a period of time.

Energy storage on an industrial level is difficult and expensive, and substantially unexplored, with the exception of pumped hydroelectricity storage systems, for example.

Energy storage obtained with pressurized gas is referred to as compressed-air energy storage (CAES). The pressurization of the gas produces a significant amount of heat that must be stored separately to prevent it from escaping through the wall of the high-pressure vessel while the pressurized gas is stored—of importance here is that the pressure necessary in this case for efficient pressurized energy storage can be between 50 and 100 bar, in which case the fluid may reach temperatures of 500° C. or more above the ambient temperature. It is also technologically difficult to build pressure vessels that can accommodate the necessary internal pressures, even when the heat is stored separately.

To avoid these significant disadvantages in the desirable pressure storage, placing the pressure vessel under water has been considered as a means of exploiting water pressure to accommodate the necessary internal pressure. When a fluid that can be pressurized is compressed on land or at the surface of the water, and then pumped into a high-pressure energy storage vessel a few hundred meters under water, the difference between the internal pressure and the external pressure is insubstantial, thus eliminating one of the main problems with CAES (the structure of the pressure vessel), but it is still necessary to store the thermal energy separately, on the surface of the water, and the high-pressure lines to the pressure vessels in the water still have structural problems and exhibit significant losses due to flow resistance.

The project StEnSEA (Storing Energy at Sea) established for deep-sea reservoirs proposes placing pressure vessels that contain electric pump turbines under water. When empty, the pressure vessel is flooded to the point where it contains only a residual air bubble, such that the water and air bubble therein are at the same pressure as the water surrounding it. To charge the pressure vessel, the pump turbines are powered by electricity produced at the surface of the water, which force the water out of the pressure vessel, against the external pressure. At the start, the internal and external pressures are equal, and as the vessel is charged, the air bubble expands to displace the water, resulting in a decrease in the internal pressure corresponding to the amount of water that is removed, thus increasing the difference to the external pressure and the energy necessary for pumping. Energy is consumed for pumping until the intended amount of water has been pumped out of the pressure vessel. This is how the StEnSEA pressure vessel is charged.

To discharge the StEnSEA pressure vessel, the pressurized water surrounding it is let back into the empty pressure vessel, which has a low internal pressure, through the turbines, which generate electricity that is delivered to the surface. The potential energy contained in the StEnSEA pressure vessel is discharged as it is filled back up with water.

This means the internal pressure in the charged StEnSEA pressure vessel is substantially lower than the external pressure, and this difference increases in relation to the amount of energy stored therein. At the proposed depths of 500 to 700 meters below the surface, with a spherical pressure vessel with a diameter of 30 meters, the pressure vessel made of concrete is expensive, as it requires a wall that is 2.5 meters or more thick for the intended pressure differences of 50 to 70 bar. The production of 20 MWh intended with the StEnSEA pressure vessel costs more than $3,000,000/MWh in storage capacity, which is unreasonable. So far, the project has not been pursued beyond the conceptual phase.

In other words, because of the electric underwater pump turbines, there is no need for CAES thermal storage on the surface and pressure lines running to the depth of the pressure vessel, but there must be an external pressure fluid reservoir for energy storage other than a CAES internal pressure vessel, which is too expensive to be economically feasible.

The object of the present invention is to therefore create an economically feasible external pressure fluid reservoir with a simplified structure that can be used for underwater energy storage with low internal pressure.

This problem is solved by the characterizing features of claims 1 and 22.

By filling the external pressure fluid reservoir with bulk materials in the liquid-tight wall enclosing its interior, it is already sufficiently able to the withstand high pressures arising at great depths. Because the wall is supported by the bulk materials when the internal pressure is lower than the external pressure (in the charged state), it does not have to withstand high pressures, and can have a simplified and inexpensive design, which is nevertheless impermeable to liquids. The robust bulk material filling is also inexpensive, and provides enough space for fluids such as air and water between its individual components.

With a skeletal structure that supports the external shape of the bulk material obtained with one embodiment, it is also possible to produce smaller external pressure fluid reservoirs, or fluid reservoirs with simpler designs, in which the wall itself is able to contain the bulk materials. With a skeletal structure, it is also possible to produce fluid reservoirs of any size or shape, because the skeletal structure keeps the bulk materials in the intended operating position or shape, despite gravitational forces (which are independent the depth), thus preventing movement of the bulk material due to gravity.

Because the wall and skeletal structure are formed around a pneumatic body, they can be easily produced, and can first be placed in water and filled with bulk materials after completion. This means that the wall only has to withstand low pressures caused by gravity, that do not increase at greater depths, because the wall and skeletal structure only have to be self-supporting on land, where they are not yet filled with the heavy bulk material. In the water, the wall and skeletal structure only need to support the external functional form of the bulk material filling contained therein against the lower effects gravity, but they do not themselves have to withstand the higher pressures occurring at greater depths.

On the whole, the bulk material filling obtained with the invention accommodates the pressure on the external pressure fluid reservoir, the wall of which is impermeable to fluids, in order to store fluids (e.g. water and air), and keep the bulk material in its operational position against the effects of gravity. This means that the wall itself does not have to withstand high pressures, and can therefore be produced easily and inexpensively. If an additional skeletal structure is needed, which at least helps in retaining the operational form of the bulk material filling, the wall can be even simpler.

Further preferred embodiments have the features given in the dependent claims.

The invention shall be explained in greater detail below in reference to the drawings.

Therein:

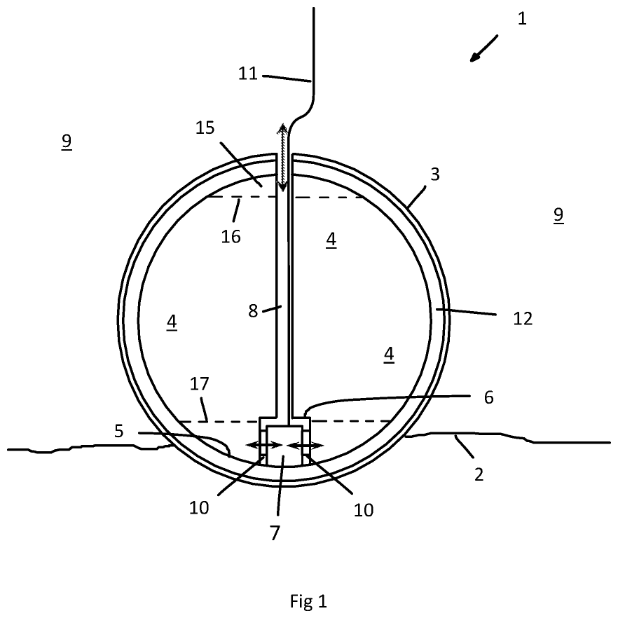

FIG. 1 shows a schematic illustration of a cross section of an external pressure fluid reservoir according to the invention with a spherical embodiment,

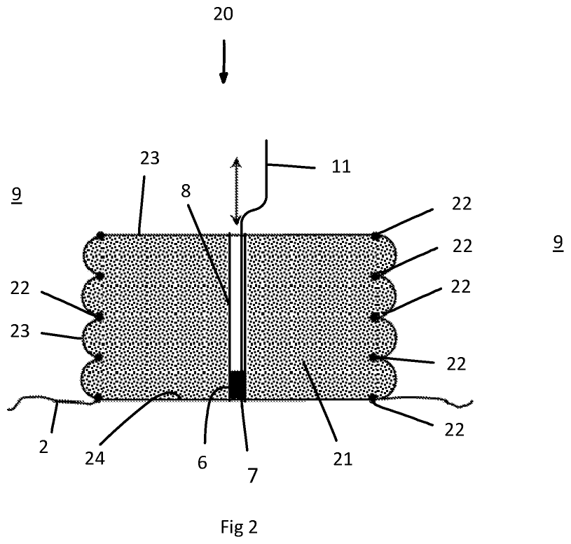

FIG. 2 shows a schematic illustration of a cross section of another external pressure fluid reservoir according to the invention with a cylindrical embodiment,

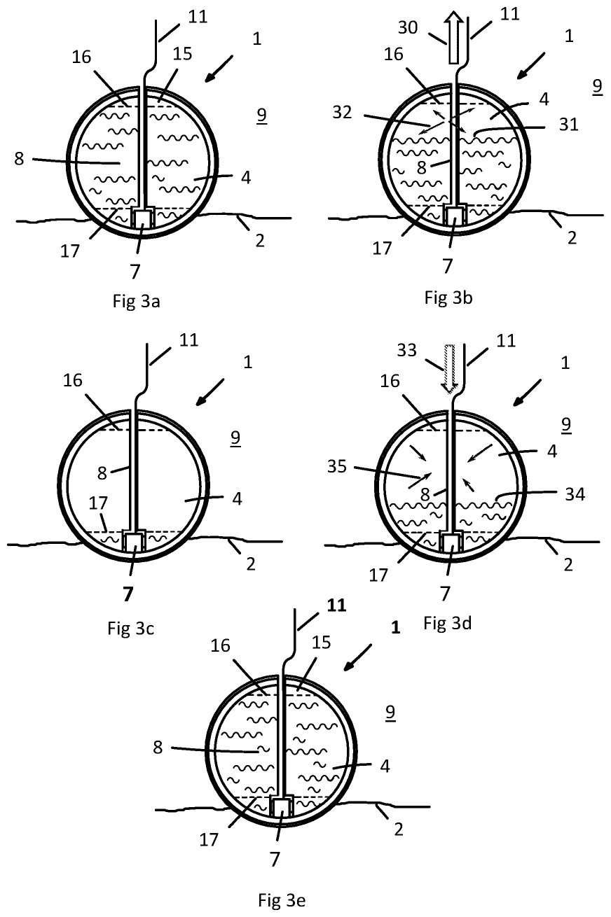

FIGS. 3a to 3e show schematic illustrations of the operating states of an external pressure fluid reservoir according to the invention,

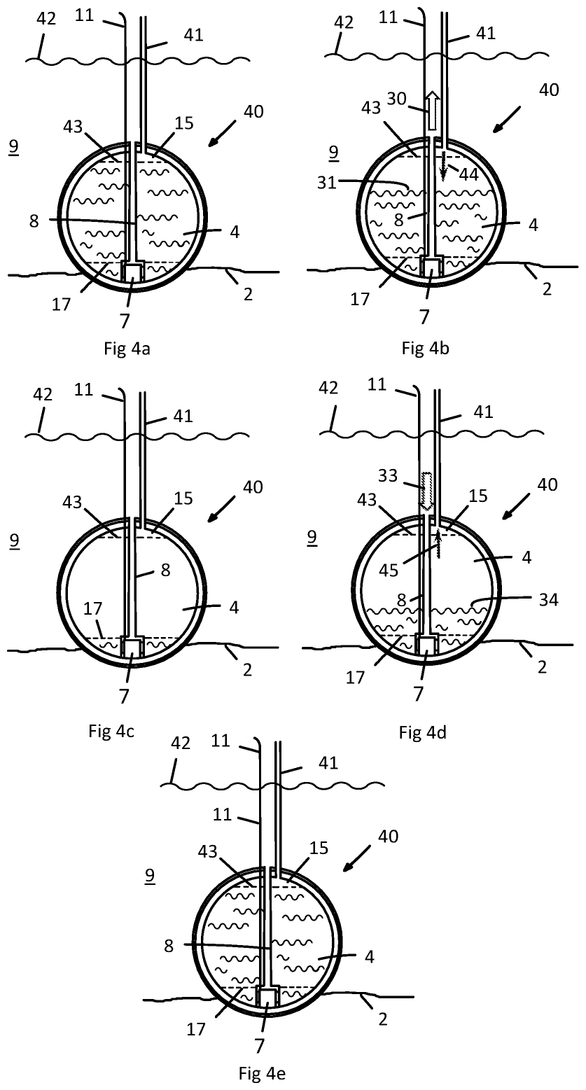

FIGS. 4a to 4e show schematic illustrations of the operating states of an external pressure fluid reservoir according to the invention that has a snorkel,

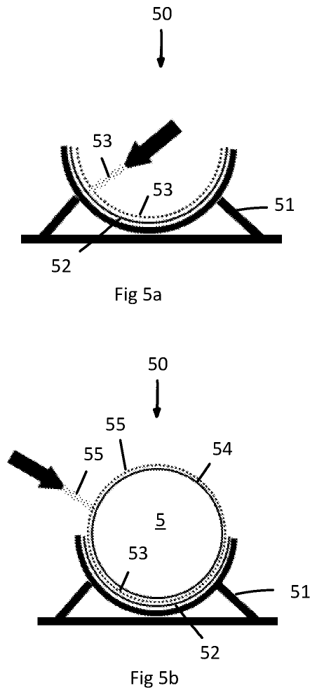

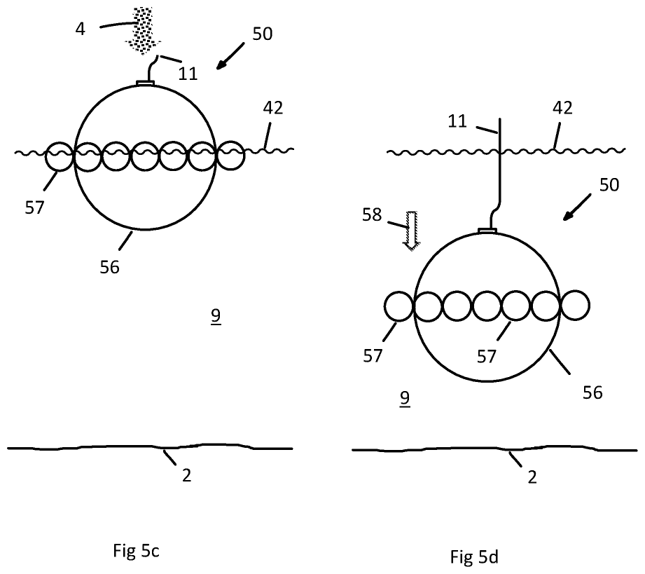

FIGS. 5a to 5d show schematic illustrations of the production method for an external pressure fluid reservoir according to the invention, and

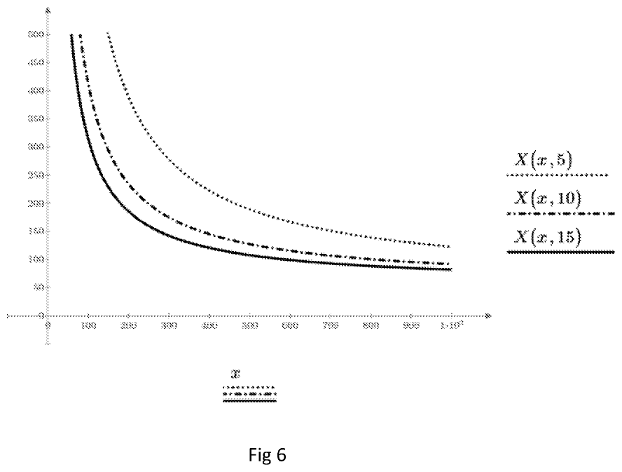

FIG. 6 shows a graph of cost estimates.

FIG. 1 shows a cross section of an embodiment of a spherical external pressure fluid reservoir 1 positioned at the bottom of the ocean 2, e.g. at a depth of 800 meters (a foundation is left out of the drawing, which can be readily added by a person skilled in the art). The body of the external pressure fluid reservoir 1 is surrounded by a wall 3 that is impermeable to fluids, encasing a bulk material filling 4, which fills a spherical interior 5 for the external pressure fluid reservoir 1. There is a chamber 6 containing a pump turbine 7 in the bottom of the external pressure fluid reservoir 1, which is connected to the exterior—in this case the surrounding ocean 9—by a central fluid channel 8 that passes through the wall 3.

The pump turbine 8 is connected by fluid lines 10 to the interior 5 and thus the bulk material filling 4, and by the fluid channel 8 to the exterior 9. The interior 5 of external pressure fluid reservoir 1 is therefore connected to the exterior, i.e. the ocean 9, by the fluid lines 10, the chamber 6 and the channel 8. It is clear that the connection can be interrupted by the turbine 7, or a valve (not shown) in the connections between the interior 5 and the ocean 9, thus separating the interior 5 from the ocean 9.

The pump turbine 7 also has a power line 11 that leads to the surface of the water, with which electricity can be supplied to the pump turbine 7 when it functions as a pump, and with which the pump turbine can supply electricity to an installation on the surface when functioning as a turbine. As stated above, solar or wind energy can be used to power the pump turbine 7 when functioning as a pump, and electricity can be delivered by the pump turbine 7 to the surface of the water, or to an installation on land, to make use of the electricity, when functioning as a turbine. It should be noted that the pump turbine 7 (including the chamber 6 and the installations therein) does not need to be inside the external pressure fluid reservoir, but can also be on the outside thereof (and therefore in the exterior).

The bulk material 4 can contain coarse sand, gravel, crushed rock, and/or stone fragments, etc. Any material that can be poured can be used, as long as its particles are robust enough to withstand the pressures arising at the depths where the external pressure fluid reservoir 1 is to be put to use (see below). Because a certain amount of empty space is naturally formed between these particles, which are not bonded to one another two dimensionally, but form a more or less stable three dimensional structure, a fluid, either air or water, can flow through all of the bulk material 4. By way of example, with gravel, ca. 30% of the overall volume is empty space, such that an external pressure fluid reservoir 1 with a radius of 10 meters can accommodate ca. 1,250 m³ of fluid when gravel is used for the filling 4. The resistance in this case is at an acceptable level, although it increases with finer bulk materials containing smaller particles. For this reason, the person skilled in the art would use coarse sand, i.e. a sand filling with comparatively large grains of sand, or an even coarser bulk material, to obtain an acceptable flow resistance. When sand is referred to herein, this is a coarse sand, with average grains of 6 mm or more.

With the aforementioned 10 meter radius, a bulk material filling composed of gravel weighs ca. 6,800 metric tons, with a buoyancy of ca. 2,800 metric tons. Even under water, the bulk material still weighs ca. 4,000 metric tons, but its shape (a sphere) must still be retained mechanically, as it would otherwise assume the shape of a cone due to gravitational forces.

Depending on the size or shape of the external pressure fluid reservoir, and the strength of the wall, the wall itself can define and retain the shape of the filling. This is the case with small external pressure fluid reservoirs, which can withstand the pressures exerted by the bulk materials, or with conical reservoirs, e.g. without an overhanging wall, which instead spread outward toward the bottom.

A skeletal structure, formed by an intermediate layer 12 in the embodiment shown in FIG. 1, which encases the filling 4, or the interior 5, can reinforce the wall 3. The skeletal structure acts against gravity, and prevents (with the wall 3, depending on the design thereof) the bulk material 4 from shifting sideways or downward, and spreading out over the bottom of the ocean 2. Consequently, the external pressure fluid reservoir 1 can, but does not need to, contain a skeletal structure that shapes the filling 4 for its intended purpose.

In the embodiment shown here, the skeletal structure is formed by a rigid intermediate layer 12, forming a spherical shell. Concretely, only a lower shell is needed, containing the filling 4 up to a level where its external shape will not change (potentially in conjunction with the wall). Consequently, the external pressure fluid reservoir 1 preferably has a rigid intermediate layer between the wall 3 and the filling 4, which encases the filling 4 at least such that it retains its operational external shape when subjected to gravitational forces. The intermediate layer 12 forming the skeletal structure is preferably made of shotcrete, which is ideal for producing a three dimensional intermediate layer with a curved surface. It should be noted that the skeletal structure can also be a steel mesh enclosing the filling, or a thin intermediate layer containing a steel mesh, etc. resulting in an embodiment not shown in the drawings.

FIG. 1 shows in particular that the interior 5 of the external pressure fluid reservoir 5 contains the filling 4.

When in use, the external pressure fluid reservoir 1 is flooded with seawater to an upper level 16 of the interior 5, or the bulk material filling 4, leaving a residual air bubble, as explained above in reference to the StEnSEA project and shown in detail in FIGS. 3a-3e, such that the space between the bulk materials, or the interior 5, is filled with water, except for the volume occupied by the air bubble 15 (the bulk material 4 also fills the volume occupied by the air bubble 15). When water is pumped out of the interior 5 by the turbine pump 7 while the external pressure fluid reservoir 1 is in use, e.g. to a lower level 17, the air volume increases accordingly, such that its pressure, and therefore the pressure in the interior 5, or the bulk material filling 4, corresponds to the increase in volume.

When the air bubble 15 reaches the same pressure as the surrounding seawater 9 due to the flooding, which is 80 bar at 800 meters, the internal pressure in the interior 5 or the filling 4 is also 80 bar. If water is pumped out of the interior 5, or filling 4, to a lower level 17 by the pump turbine 7 when it is supplied with electricity by the power line 11, the internal pressure drops continuously to, e.g., 1 bar, once the lower level 17 has been reached. The pressure difference between the constant external pressure, of 80 bar, and the inner pressure then increases to a maximum of 79 bar.

Depending on the design of the external pressure fluid reservoir 1 (operational depth, i.e. the depth of the fluid reservoir 1, upper and lower water levels 16, 17, etc.) this pressure difference reaches a maximum, referred to here as the predetermined maximum operational pressure difference, in contrast to a current operational pressure difference, which is the case when the current water level in the interior 5 is between the minimum level 17 and the maximum level 16. In general, the predetermined maximum operational pressure difference refers to the maximum pressure difference when the external pressure fluid reservoir is fully charged.

The wall 3 separates the interior 5, or bulk material filling 4, form the exterior (the ocean 9 in this case), in a liquid-tight manner, such that the residual air bubble, or any gas in the external pressure fluid reservoir remains trapped in the interior 5, and the water therein is pumped out through the fluid channel 8, and can be returned thereto through the operational pressure difference. This results in pressure applied to the wall from the exterior, in this case the pressure of the ocean 9, with a value corresponding to the current operational pressure difference, which can be as much as the maximum predetermined operational pressure difference. The wall 3 is not designed to withstand this predetermined maximum operational pressure difference, and instead is pressed against the intermediate layer 12 forming the skeletal structure by the external pressure in the embodiment shown here.

The intermediate layer 12 is also not designed to withstand the predetermined maximum operational pressure difference, and it is pressed in turn by the wall 3 against the filling 4 (the purpose of the intermediate layer 12 is to retain the shape of the filling 4 and therefore the interior 5).

The bulk material filling 4 can withstand pressures, such that it does not collapse when subjected to the predetermined maximum operational pressure difference, thus supporting the wall 3 through the intermediate layer 12 (which would otherwise collapse under pressure).

On the whole, the wall is therefore designed to absorb the predetermined maximum operational pressure difference resulting from a difference in the external and internal pressures when in use (via the skeletal structure in this case) and conduct this pressure into the filling, which in turn is held in its operational shape by the wall and intermediate layer, against the excessive external pressure.

Consequently, the person skilled in the art only needs to be concerned with the impermeability to fluids and the shape of the filling 4 when designing the wall 3 and the intermediate layer 12, while the compression strength required for the predetermined maximum operational pressure difference that cannot be resolved in the prior art is of no consequence here. With regard to the operational depths desired for greater energy storage capacities, this is decisive for a simple and inexpensive construction of both the wall 3 and the skeletal structure formed by an intermediate layer 12 in this case.

Depending on what bulk material 4 is used, and the operational depth of the external pressure fluid reservoir 1, the filling 4 may become slightly deformed as the predetermined maximum operational pressure difference builds up, in that the bulk material particles shift slightly, particularly at the top, until they are pressed together enough to prevent further shifting. This can result in slight changes to the bearing surfaces of the wall 3 or intermediate layer 12, likewise altering the supporting effect of the filling 4 for the intermediate layer 12, and consequently the wall 3.

Because the intermediate layer 12, which is made of shotcrete for example, is rigid, but not able to withstand the (intended) predetermined maximum operational pressure difference, cracks may form as this pressure difference increases, resulting in breaks, and the pieces that break off may shift slightly in reaction to the shifting of the surface of the filling 4 in the interior 5, after which they stabilize. This stability in the new position may be supported by a steel reinforcement designed to accommodate this deformation in the intermediate layer 12 and the wall 3, which clamps the pieces between it and the filling, such that they are fixed in place. The intermediate layer 12, and potentially the wall 3, can still retain the external shape of the filling 4. The operational depth, and therefore the maximum operational pressure difference, is irrelevant, even if it results in breakages in the intermediate layer 12, unless the wall also needs to be designed to accommodate a fractured intermediate layer 12, although this is inconsequential in comparison to the difficulty of obtaining a wall that can withstand the predetermined maximum operational pressure difference.

The fluid-tight wall 3 is therefore elastic, or can be deformed, or has joints, such that it still bears on the intermediate layer 12, or its slightly shifted broken pieces, thus still conducting the predetermined maximum operational pressure difference into the filling 4. The wall 3 can form a flexible skin encompassing the interior 5 and the filling 4. At least part of the wall can preferably contain a plastic film, fabric, and/or flat panel. The wall 3 is preferably made entirely of a flexible plastic film or fabric. Because the broken edges of shotcrete are not very sharp, and instead tend to conform to the rounded surfaces of the aggregate, such as sand, commercially available plastic films can be used therewith. It is easy for the person skilled in the art to determine which shotcrete to use with which film. The wall 3 is preferably flexible, such that it can conform to any shifting of the reinforcing bulk material 4 when subjected to the predetermined operational pressure differences.

It should be noted here that the preferred features described above in reference to the intermediate layer 12 do not require an intermediate layer 12 or skeletal structure, but can also display advantages when the wall bears directly on the bulk material.

Because concrete in general can withstand heavy loads, the intermediate layer 12 that preferably contains shotcrete is able to withstand the operational external pressures, i.e. the water pressure where the external pressure fluid reservoir 1 is located. This has advantages, because the necessary displacement of the flexible wall 3 is limited to the shifting of the broken pieces of the intermediate layer 12, and is not further increased by a change in the volume of the broken material from the intermediate layer.

In general, this results in an external pressure fluid reservoir obtained with the invention, the wall 3 of which cannot withstand the predetermined maximum operational pressure difference between the external pressure and the pressure in the interior 5, which can nevertheless withstand this pressure by bearing on the filling 4. As stated above, the incapacity to withstand pressure means that the wall 3 cannot withstand the operational pressure difference, and instead would collapse without reinforcement. The capacity to withstand pressure due to the reinforcement of the filling 4 means that the wall 3, which bears on the pressure-resistant filling 4, will not collapse when subjected to the predetermined maximum operational pressure difference, i.e. it retains its operational shape, and therefore remains impermeable to fluids. It is irrelevant whether this reinforcement is obtained with an intermediate layer 12 that remains intact or is broken, or is obtained directly, without an intermediate layer 12 or skeletal structure.

Consequently, the external pressure fluid reservoir can fundamentally be designed independently of the intended operational depth, thus allowing for a simple and inexpensive construction, even if the filling becomes deformed, depending on the type of filling and the operational depth. The size of the wall and the skeletal structure, if there is one, is based on the shape of the bulk material and a potential deformation thereof, but not the operational depth itself.

In other words, the wall is designed in accordance with the invention such that it accommodates the external pressure exceeding the pressure in the interior, and conducts this into the filling, which remains in its operational position when subjected to higher external pressures.

FIG. 2 shows another embodiment of an external pressure fluid reservoir 20, which, unlike the embodiment shown in FIG. 1, has a cylindrical filling 21 and a skeletal structure with structural elements, preferably steel rings 22. The filling 21 is contained in a flexible wall 23, over which the rings 22 are placed, spaced apart from one another, such that the cylindrical shape of the filling 21 is retained. As in the embodiment shown in FIG. 1, the filling 21 forms the interior 24 of the external pressure fluid reservoir 20.

The wall 23 is preferably made of a polyester/PVC fabric. A central fluid channel 8 contains a chamber 6 for a pump turbine 7, as is the case in the embodiment shown in FIG. 1, which is connected to the filling 21. The skeletal structure preferably contains structural elements that are preferably placed on the outside of the wall. These structural elements are preferably rings 22.

In the embodiment shown in FIG. 2, the wall 23 bears directly on the filling, such that the current or predetermined maximum operational pressure differences is conducted directly into the filling, without an intermediate layer 12 (FIG. 1), which in turn supports the wall 23 in its operational position against any pressure differences, up to the predetermined maximum operational pressure difference. The rings 22 are placed on the wall 23, thus preventing bulging of the cylindrical shape of the filling 21 over its height.

The wall 23 does bulge between two rings 22, as is intended, but the tensile load to the wall 23 is relatively low, in that it is a function of the radius of the bulge, in particular if the dimensions of the wall 23 are such that the cross section of the bulge forms an arc segment that is less than or equal to a semicircle. The tensile load to the cylindrical wall can be kept low through the distance between adjacent rings 22 and the dimensions of the wall 23, thus reducing the demands on the material forming the wall 23, and lowering the costs for the wall 23. It should be noted here that the bottom 25 and the top 26 of the wall 23, formed at the lowest and highest rings 22, are not subject to tensile loads.

FIG. 2 shows that with a cylindrical design for the filling 21, or interior 24, aside from in the bulges, all of the bulk material is located above the surface outlined by the base, such that the lateral forces that the wall 23 has to accommodate to retain the cylindrical shape are minimal, thus simplifying the design of the wall 23 and the rings 22.

The fundamental functioning of the external pressure fluid reservoir 20 is the same as that for the fluid reservoir shown in FIG. 1. All of the embodiments of an external pressure fluid reservoir obtained with the invention can be larger than 5 meters, preferably larger than 10 meters, more preferably larger than 15 meters, and particularly preferably larger than 20 meters along at least one dimension. This means that the embodiment in FIG. 1 can have a radius and/or height of 10 meters or more, and the radius and height of the embodiment in FIG. 2 can each be 15 meters. Preferably, the radius of the bulges between two rings 22 can be approx. 1 meter. The interior spaces 5 (in FIG. 1) or 24 (in FIG. 2) can be spherical or cylindrical, respectively, or they can be cubical, or exhibit some other shape.

As with the embodiment in FIG. 1, the external pressure fluid reservoir 20 contains a pump turbine 7, with which fluids can be exchanged (through fluid lines 10, the chamber 6, and the channel 8) when in operation. This pump turbine 7 could also be placed outside the reservoir 20.

This results in an external pressure fluid reservoir 20 with an interior 24 that has a cylindrical structure, and preferably has a number of rings 22 arranged vertically, that have the same radius, and are placed over a flexible wall 23, in which there is a vertical channel 8 forming a connection for the exchange of fluids, which contains a pump turbine 7.

FIGS. 3a to 3e schematically show the different operational states of an external pressure fluid reservoir 1 placed on the bottom of the ocean, in the embodiment shown in FIG. 1, but can also have another design, or other preferred features.

FIG. 3a shows the external pressure fluid reservoir 1 in the “discharged” state, in which the interior 5, or filling 4 is flooded, leaving just a residual air bubble 15, and the inner pressure corresponds to the external pressure of 80 bar (at the operational depth of 800 meters assumed in the description of FIG. 1). The current operational pressure difference is therefore zero. The fluid-tight wall 3 prevents the air in the residual air bubble 15 from escaping. The intermediate layer 12, along with the wall 3, ensures that the filling 4 retains its spherical shape. The connection between the interior 5 and the ocean 9 is preferably closed, but it could be open at this point.

FIG. 3b shows the external pressure fluid reservoir 1 in the “energy storage” state, in which the connection between the interior 5 and the ocean 9 is open, the pump turbine 7 pumps water 11 out of the interior 5 using electricity provided by the power line 11, such that the water flows out through the channel 8 in the direction of the arrow 30. This decreases the water level 31 in the filling 4. The air bubble 15 (FIG. 3a) expands in the spaces formed between the filling 4 above the decreasing water level 31 (see the expansion arrows 32) to the extent that the current water level 30 has decreased toward the lower level 17. The pressure in the filling 4 consequently drops continuously, i.e. the current operational pressure difference increases continuously, due to the pressure applied to the wall 3, conducted through the intermediate layer into the filling 4, which accommodates the operational pressure difference. As the operational pressure difference increases, the electricity required for and consumed (but recoverable) by the pump through the power line 11 increases.

Depending on the design of the external pressure fluid reservoir 1, in particular the bulk material that is used, the design of the intermediate layer 12, and the intended operational depth, a point is reached with the increase in the operational pressure difference, at which the intermediate layer 12 fractures, in that peripheral particles of the bulk material shift slightly (see above). This point can be anywhere between when the operational pressure difference is zero and the predetermined maximum operational pressure difference, and is determined by the person skilled in the art to obtain an optimal design of the wall and intermediate layer (and an optimal selection of the bulk material).

FIG. 3c shows the external pressure fluid reservoir 1 in the “charged” state, in which the pump turbine 7 has pumped the water out of the interior 5 to the lower level 17, the air bubble 15 (FIG. 3a) has expanded to fill all of the space between the bulk material 4, aside from the lower water level 17, exhibiting a pressure of 1 bar, or 0.05 bar, depending on the design. The power consumption through the line 11 has reached ca. 20 MWh (based on a radius of the interior 5 of 10 meters, and an operational depth of 800 meters, see the description in reference to FIG. 1). The filling 4 still withstands the current predetermined maximum operational pressure difference, and supports the wall 3 against the external pressure through the potentially broken intermediate layer 12. The connection between the interior 5 and the ocean 9 is closed.

The external pressure fluid reservoir 1 can remain in the “charged” state until the energy stored therein is needed. As a matter of course, a partially charged fluid reservoir 1 can also remain partially charged.

FIG. 3d shows the external pressure fluid reservoir 1 in the “stored energy discharge” state, in which the connection between the interior 5 and the ocean 9 is open, water from the ocean 9 enters the fluid channel 8 due to the operational pressure difference, in the direction indicated by the arrow 33, thus entering the pump turbine 7, which functions as a turbine to power a generator that generates electricity which is delivered through the power line 11 to the surface. The water filling the interior 5 or bulk material 4, is at an increasing level 34, which compresses the air above the water in the spaces between the filling 4, as indicated by the compression arrows 35. The current operational pressure difference decreases continuously. The filling 4 still withstands the current operational pressure difference, and supports the wall 3 against the external pressure through the potentially broken intermediate layer 12.

FIG. 3d shows the external pressure fluid reservoir 1 in the discharged state that it reaches after current water level 34 (FIG. 3d) has reached the upper level 16. This corresponds to the state shown in FIG. 3a.

FIGS. 4a to 4e schematically show the different operating states of another embodiment of an external pressure fluid reservoir 40 on the bottom of the ocean 2, in which the embodiment shown in FIG. 1 is supplemented with a snorkel 41 connecting the interior 5, or filling 4, to the atmosphere above the surface 42 of the water in the ocean 9.

Because of the snorkel 41, the pressure inside the external pressure fluid reservoir 40 is always at the atmospheric pressure. The upper water level 43 no longer has to accommodate a residual air bubble 15 (FIG. 1), and instead can completely fill the interior 5.

FIG. 4a shows the external pressure fluid reservoir 1 in the “discharged” state, in which the interior 5, or filling 4, is flooded, and the internal pressure is 1 bar, due to the connection to the atmosphere. The current operational pressure difference is the same as the predetermined maximum operational pressure difference of 80 bar. The connection between the interior 5 and the ocean 9 is open, because water would otherwise climb up the snorkel in an undesired manner. The fluid-tight wall 3 prevents water from entering into the interior. The intermediate layer 12 is already broken, depending on the bulk material that is used (see the description in reference to FIG. 3b), and ensures that the filling 4 retains its spherical shape.

FIG. 4b shows the external pressure fluid reservoir 1 in the “energy storage” state, in which the connection between the interior 5 and the ocean 9 is open, and the pump turbine 7 pumps water out of the in interior 5 consuming electricity through the power line 11, such that the water flows through the channel 8 into the exterior in the direction of the arrow 30. The current level 31 of the water in the filling 4 depends on how much water has been removed. Air coming from the snorkel 41 fills the space between the bulk material 4 above the current water level 31 (see arrow 44) to the extent that the current water level 31 decreases toward the lower level 17. The pump in the pump turbine 7 works against the entire intended maximum operational pressure difference, therefore consuming more electricity from the power line 11 than with the external pressure fluid reservoir 1 shown in FIG. 3b.

FIG. 4c shows the external pressure fluid reservoir 1 in the “charged” state, in which the connection between the interior 5 and the ocean 9 is closed, the pump turbine 7 has pumped the water out of the interior 5 to the lower level 17, the air supplied from the atmosphere through the snorkel 41 fills all of the space between the bulk material 4 to the lower water level 17, and the pressure still remains at 1 bar. The power consumption through the power line 11 reaches ca. 21 MWh (based on a radius of the interior 5 of 10 meters, and an operational depth of 800 meters). The filling 4 still withstands the predetermined maximum operational pressure difference, and supports the wall through the potentially broken intermediate layer 12 against the external pressure.

The external pressure fluid reservoir 41 can remain in the “charged” state until the energy stored therein is needed. As a matter of course, a partially charged fluid reservoir 1 can also remain partially charged.

FIG. 4d shows the external pressure fluid reservoir 1 in the “stored energy discharge” state, in which the connection between the interior 5 and the ocean 9 is open, water from the ocean 9 enters the fluid channel 8 due to the predetermined maximum operational pressure difference in the direction of the arrow 33, and thus ends up in the pump turbine 7, which functions as a turbine powering a generator that generates electricity that is delivered to the surface through the power line 11. The water filling the interior 5, or filling 4, is at a continuously increasing level 34, which forces the air above it in the spaces between the bulk material 4 through the snorkel 41 into the atmosphere in the direction indicated by the arrow 45. The predetermined maximum operational pressure difference is retained. The filling 4 continues to accommodate this pressure, and supports the wall 3 through the potentially broken intermediate layer 12 against the external pressure.

FIG. 4d shows the external pressure fluid reservoir 1 in the “discharged” state that it reaches after the current water level 34 (FIG. 3d) has reached the upper level 43. This corresponds to the state shown in FIG. 4a.

The invention results in an external pressure fluid reservoir that has an interior for accommodating a fluid, and external wall that is subjected to an external pressure when in use, which separates the interior form the exterior in a fluid-tight manner, and a connection between the interior and exterior with which an exchange of fluids can be obtained between the interior and exterior, wherein the interior is filled with a bulk material, and the wall is designed such that it is subjected an external pressure exceeding the internal pressure, which is conducted into the bulk material, with which it withstands the increasing external pressure when in operation.

FIG. 5a schematically shows the production of an external pressure fluid reservoir 50 in the embodiment shown in FIG. 1, wherein the production takes place in a mold 51 for the lower half of the fluid reservoir 50, in which a plastic film 52 is placed that then forms the wall for the finished fluid reservoir. The plastic film 52 receives a first shotcrete layer 55 on the inside, which forms an intermediate layer 12 (FIG. 1) for the lower half of the fluid reservoir 50.

FIG. 5b shows a pneumatic body 54 placed in the first shotcrete layer 53 after it has hardened, which forms the interior 5 (FIG. 1) of the finished fluid reservoir after it has been inflated. A second shotcrete layer 55 is applied to the pneumatic body 54, which is bonded to the first shotcrete layer 53, thus forming the complete intermediate layer 12 (FIG. 1). A second plastic film, not shown in the drawings, is then applied to the second shotcrete layer 55, which is then bonded to the first plastic film 52 to obtain the wall 3 (FIG. 1). The intermediate layer 12 and wall 3 are then complete, such that the pump turbine 7 and power line 11 (FIG. 1) can be placed in the chamber 56 (FIG. 5c) formed between the intermediate layer 12 and the wall 3. The reservoir then needs to be filled with bulk material 4.

FIG. 5c shows the chamber 56 formed by the wall 3 and the shotcrete layers 53, 55 after it has been place in water, to which floats 57 are attached, such that the chamber floats and can be filled with bulk material 4, at which point the external pressure fluid reservoir 50 is complete. FIG. 5d shows how, by reducing the buoyancy of the floats 57 at the future installation location, the external pressure fluid reservoir 50 can be sunk to the operational depth in the direction indicated by the arrow 58.

This results in a method for producing an external pressure fluid reservoir that has an interior for accommodating a fluid, and outer wall that is subject to an external pressure when in use, which separates the interior from the exterior in a fluid-tight manner, wherein the interior is filled with a bulk material that supports the wall against an operational pressure difference, and wherein a lower part of the external pressure fluid reservoir is first produced, after which a pneumatic body is placed in the lower part and inflated, until it corresponds to the intended shape of the interior, after which a skeletal structure and the wall are placed thereon, wherein a hole is formed at the top of the wall, such that the filling can be later introduced into the interior formed by the wall. The filling is preferably added after the wall, supported by the skeletal structure, has been placed in water, where it can then be sunk. The pneumatic body is preferably spherical when inflated, and the skeletal structure is also preferably formed on the pneumatic body by a shotcrete layer.

It should be noted that the external pressure fluid reservoir can theoretically be used in any body of water, i.e. saltwater or fresh water, as well as in an underground water reservoir at the bottom of a cavern.

FIG. 6 shows a graph 60, in which the costs for the external pressure fluid reservoir in $/kWh are plotted on the y-axis, and the operational depth is plotted on the x-axis. Assuming that the fluid reservoir is spherical, the solid line 61 indicates the costs for a radius of 5 meters, the line 62 composed of dots and dashes indicates costs for a radius of 10 meters, and the dotted line 63 indicates costs for a radius of 15 meters. These costs are significantly lower than those for an external pressure fluid reservoir from the prior art.

I claim:

1. An external pressure fluid reservoir that has an interior in which a fluid can be accommodated, an outer wall subjected to an external pressure when in use, which separates the interior from the exterior in a fluid-tight manner, and a connection between the interior and the exterior for exchanging fluid between the interior and the exterior wherein the interior is filled with a bulk material, and the wall is designed to conduct external pressure exceeding that in the interior into the filling to withstand the external pressure when in use.

2. The external pressure fluid reservoir of according the claim 1, wherein the wall itself cannot withstand a predetermined operational pressure difference between the external pressure and the pressure in the interior, but is supported by the bulk material.

3. The external pressure fluid reservoir of claim 1, wherein the wall is flexible, such that it can conform to a shifting in the bulk material that occurs at the predetermined operational pressure difference, while remaining fluid-tight.

4. The external pressure fluid reservoir of claim 1, wherein the wall forms a flexible skin encompassing the interior.

5. The external pressure fluid reservoir of claim 1, wherein part of the wall contains a plastic film, plastic fabric, and/or flat panel.

6. The external pressure fluid reservoir of claim 1, which has a skeletal structure that supports the outer shape of the bulk material.

7. The external pressure fluid reservoir of according claim 6, wherein the skeletal structure contains a rigid intermediate layer between the wall and the bulk material-filling, which encases the bulk material-filling at least to the extent that its external shape is retained despite gravitational forces.

8. The external pressure fluid reservoir of according claim 7, wherein the intermediate layer contains a material that can substantially withstand the external operational pressure.

9. The external pressure fluid reservoir of according the claim 7, wherein the intermediate layer is made of shotcrete.

10. The external pressure fluid reservoir of according claim 6, wherein the skeletal structure contains structural elements, preferably placed on the outside of the wall.

11. The external pressure fluid reservoir of according the claim 10, wherein the structural elements are rings.

12. The external pressure fluid reservoir of according claim 1, wherein the bulk material is coarse sand, gravel, crushed rock, and/or stone fragments.

13. The external pressure fluid reservoir of according claim 1, wherein the interior is spherical, cylindrical, or cubical.

14. The external pressure fluid reservoir of according claim 1, wherein the size of the interior is greater than 5 meters, preferably greater than 10 meters, ideally greater than 15 meters, in particular greater than 20 meters, in at least one dimension.

15. The external pressure fluid reservoir of according claim 13, wherein the at least one dimension is the radius or height.

16. The external pressure fluid reservoir of according claim 1, wherein it contains a pump turbine functionally connected to the connection for exchanging fluid.

17. The external pressure fluid reservoir of according claim 1, wherein the interior is cylindrical, with a number of structural rings of the same size distributed over its height, bearing on a flexible wall, and wherein there is a vertical channel in the interior, forming the connection for fluid exchange, containing a pump turbine.

18. The external pressure fluid reservoir of claim 16, wherein the pump turbine is designed to convey water.

19. The external pressure fluid reservoir of according claim 1, wherein it is under water.

20. The external pressure fluid reservoir of according claim 1, wherein it also contains a snorkel that connects the interior to the atmosphere.

21. A method for producing an external pressure fluid reservoir that has an interior in which a fluid can be accommodated, an outer wall subjected to an external pressure when in use, which separates the interior from the exterior in a fluid-tight manner, wherein the interior is filled with a bulk material that supports the wall against an operational pressure difference, wherein first, a lower part of the external pressure fluid reservoir is produced, after which a pneumatic body is placed in the lower part and inflated to the intended size and shape of the interior, following which a skeletal structure and the wall are placed on the pneumatic body, wherein there is a hole at the top of the wall through which the bulk material can be introduced into the interior formed by the wall in a later step, to make it ready for use.

22. The method for producing an external pressure fluid reservoir of claim 21, wherein the bulk material is added after the wall, held in shape by the skeletal structure, is submerged in water, where it can be sunk to an intended location.

23. The method for producing an external pressure fluid reservoir of claim 21, wherein the pneumatic body is spherical when inflated.

24. The method for producing an external pressure fluid reservoir of claim 21, wherein the skeletal structure is formed by a shotcrete layer sprayed onto the pneumatic body.
